(19) United States
(12) Patent Application Publication
(10) Pub. No.: US 2014/0114920 A1
(43) Pub. Date: Apr. 24, 2014

(54) Method For Synchronizing Files

(71) Applicants: HAIER GROUP CORPORATION, Qingdao (CN); SUZHOU HAIER INF & TECH CO., LIMITED, Qingdao (CN)

(72) Inventors: Yanping Zhang, Qingdao (CN); Junbo Jia, Qingdao (CN); Zhiqiang Chen, Qingdao (CN); Bingyu Li, Qingdao (CN)

(73) Assignees: SUZHOU HAIER INF&TECH CO., LIMITED, Qingdao (CN); HAIER GROUP CORPORATION, Qingdao (CN)

(21) Appl. No.: 13/712,936

(22) Filed: Dec. 12, 2012

(30) Foreign Application Priority Data
Oct. 19, 2012 (CN) 201210402245.8

(51) Int. Cl. G06F 17/30

(52) U.S. Cl. CPC G06F 17/30174
USPC 707/634

(57) ABSTRACT

A method for synchronizing a file, comprising the following steps: a step for receiving a synchronously uploaded file, dividing the content of said uploaded file into a head portion, and a rest portion and producing corresponding files which are respectively corresponding to said head portion and said rest portion by means of a server; a step for downloading said corresponding files which is corresponding to said head portion of the content of each said uploaded file to a terminal by means of said server; a step for downloading said corresponding files which is corresponding to said rest portion of the content of each said uploaded file to said terminal, and combining said corresponding files which is corresponding to said rest portion with said corresponding files which is corresponding to said head portion by means of said server.

This U.S. application claims priority to the Chinese patent application 201210402245.8 filed Oct. 19, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is data transmission, especially relates to a method for synchronizing files.

### BACKGROUND

The following description includes information that may be useful in understanding the present invention. It is not an admission that any of the information provided herein is prior art or relevant to the presently claimed invention, or that any publication specifically or implicitly referenced is prior art.

FIG. 1 illustrates a networking environment 100 in which file synchronization can be performed. As shown, the networking environment 100 comprises several terminals 120-150 and a server 110. When an user processes a file on a terminal, if the user needs to leave from this terminal to use another terminal to continue processing the same file, the user may utilize a synchronization function to upload the processed file synchronously to the server by means of the present terminal, and start the synchronization function at the other terminal to download the corresponding file from the server, so that the file synchronization between the terminals is achieved.

For example, when a text file and etc is being edited by means of a computer of a firm, a synchronization function may be started to upload the text file to a server, and the text file may be downloaded from the server to a home personal computer (PC) by starting a synchronization function of the home PC.

As another example, when a local video file is being played by a tablet device (e.g., Apple® iPad®, etc.) or a cell phone somewhere, the video file, information on the progress of playing and other configuration files is uploaded to a server by starting the synchronization function. When a user starts the synchronization function for the video file at another terminal, the corresponding video file, the information on the progress of playing, and the configuration file, etc, are downloaded, so that the video file can be continuously played for watching at the other terminal.

After updating a file to the server by the user, the user cannot browse this file until the file which is synchronously uploaded to the server by the user, and is downloaded completely when the user synchronously downloads the file at the other terminal. At present, as the number of files synchronized by user is increasing, the downloading time being consumed is increasing accordingly. Especially, the time being consumed to synchronously download several large files, such as several audio and/or video files, can be huge. Thus, there is still a need to have an improved file synchronization technique to complete synchronous files downloading as fast as possible so that the user may perform operations such as browsing, previewing, name changing, deleting and other basic operations on those files.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The purpose of the present invention is to provide a method for synchronizing files so as to quickly process files synchronously downloaded.

The method for synchronizing files provided by the present invention file, comprises the following steps:
step A: receiving synchronously uploaded files, dividing the content of said uploaded files into a head portion, and a rest portion and producing corresponding files which respectively correspond to said head portion and said rest portion by means of a server;
step B: downloading said corresponding files which correspond to said head portion of the content of each of said uploaded files to a terminal by means of said server;
step C: downloading said corresponding files which correspond to said rest portion of the content of each of said uploaded files to said terminal, and combining said corresponding files which correspond to said rest portions with said corresponding files which correspond to said head portions by means of said server.

It can be seen from above that the file to be synchronously downloaded is divided to a head portion and a rest portion. The head portion is downloaded first during synchronously downloading. Due to the small size of the synchronously downloaded head portion file, the synchronously downloading may be completed very soon. When the head portion is downloaded, the user may begin to operate on the file. After that, during operations of the file, the rest portion is downloaded and then combined with the head portion so that the operation(s) that have been performed on the head portion file is carried through to the completed file.

Optionally, according to the present invention, the method further comprises the following step. In some embodiments, the following step is performed between said steps B and C: a step for representing each of the files which corresponds to said head portion in the form of an icon within a graphical user interface and providing a preview of the files to a user by means of said terminal.

It can be seen from above, after only downloading the head portion files, the terminal may generate a preview or an icon view of the files. In addition, the user may also perform basic operations, such as deletion, file name changing, executing (opening the file using a native application of the terminal) of the head portion files which are synchronously downloaded to the terminal. This may give the user a sense that the synchronization is completed quickly since the files can be operated on as soon as possible (as soon as the head portion files are downloaded). At this moment the user does not know the synchronously downloaded files are only the files corresponding to each head portion.

Optionally, according to the present invention, the method further comprises the following step, which in some embodiments, can be performed before said step C: a step for identifying a file currently operated on by means of said terminal, downloading a corresponding file which corresponds to a rest portion of said currently operated file to said terminal and combining said rest portion of said currently operated file with a head portion of said currently operated file.

At this moment, preferably, the file corresponding to the rest portion of an executed file is synchronously downloaded and combined with the file corresponding to the head portion behind the scene (i.e., hiding from the user) so as to allow the user operate on the completed file and prevent the user from knowing that the executed file is not completed.

Optionally, according to the present invention, said downloading in the steps B and D comprises downloading based on a certain priority order.

Optionally, according to the present invention, said priority order comprises: preferentially downloading a file with a common file type corresponding to a model of device (i.e., a file type(s) that is frequently used by the specific model of device).

Optionally, according to the present invention, said priority order further comprises: an order based on a file updating time, and/or an order based on the operating frequency of a file.

It can be seen from that on the basis of a certain strategy, that is, due to downloading based on a certain priority order, a file with a common file type corresponding to a terminal, or a file with attention paid by the user, or a file with a frequent execution, can be synchronously downloaded preferentially, so that it is convenient for the user to preferentially execute a certain file in time.

Optionally, according to the present invention, said common file type corresponding to a model of device comprises: an audio/video file type corresponding to a mobile terminal; a text file type corresponding to a business terminal.

It can be seen from that an audio/video file type is specified as the common file type for a mobile terminal because users generally enjoy entertainment of this kind (generally operate on the audio/video file types) at the mobile terminal frequently. Similarly, the text file type is specified as the common file type for a business terminal so as to emphasize that the terminal is for business use. Above mentioned solution allows the common file types for each terminal device type to be specified based on which file types are frequently used by the user on a specific terminal so as to provide the user with the optimal experience.

Optionally, according to the present invention, each of said corresponding files which corresponds to said head portion of the content of said uploaded file in step A stores an identity mark (e.g., an identifier) of said corresponding file which corresponds to said rest portion of the content of said uploaded file.

Optionally, the combining in the step C is comprises combining each of said corresponding files which corresponds to said head portion with said corresponding file which corresponds to said rest portion based on said identity mark.

It can be seen from that the head portion of the content of file may record an identity mark that identifies the rest portion of the content of this file. In this case, even if the file corresponding to the head portion is operated on, such as file name changing, etc., due to the identity mark of the rest portion of the content of this file recorded thereof, the rest portion may be found based on the identity mark and combined to the head portion, so that various file operations may be supported after the downloading of the file corresponding to the head portion is completed.

Optionally, according to the present invention, said dividing in step A comprises determining the size of said head portion, the size of said uploaded file to be divided is larger than the size of said head portion (i.e., the size of the head portion is a fraction of the size of the uploaded file).

It can be seen from that the file with small size can be prevented from dividing by setting the size of head portion.

Optionally, according to the present invention, said dividing in the step A further comprises: determining a network bandwidth of file transmission between said server and said terminal, determining the size of said head portion based on said bandwidth.

It can be seen from that, if the network bandwidth is more enough to support a burst transmission for multiple large files, the more bytes may be allocated to the head portion to provide more contents to the user. This results in more transparency of the synchronization operation to the user, and a good experience for operating synchronized file is guaranteed for the user when the user operates the file corresponding to the head portion, such as browsing, opening the file. If the network bandwidth is small, the transmission for multiple large files will be very slow, and thus less bytes may be allocated to the head portion to guarantee the head portion of each file to be downloaded quickly to the terminal so that the user may not feel the existence of the file synchronization, i.e. the file synchronization is completed very soon, while the user can operate the file, such as browsing, opening file and etc.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a network environment for file synchronization;

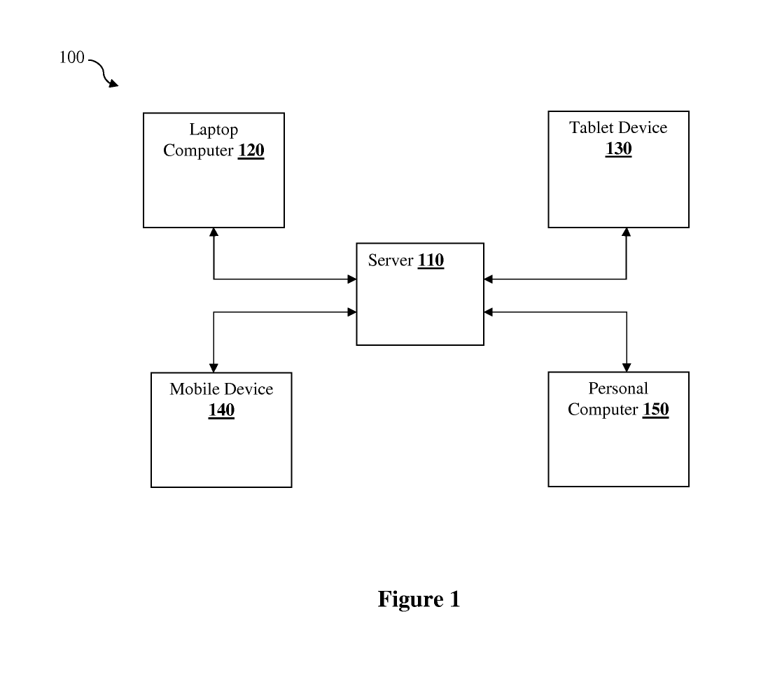

FIG. 2 illustrates a work flow for achieving synchronization.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In order to achieve the synchronization method of the present invention, a server should implement the following steps after files to be synchronized being uploaded to the server. As used herein, a server is euphemistically defined as one or more computing device that collectively provides a set of services to client computers. In some embodiments, the set of services can be implemented in a set of computing devices that is physically separated from the terminals and connected with the terminals over a network (e.g., a local area network, the Internet, etc.). In other embodiments, the set of services can be implemented within the terminal that initiating the file synchronization, such that the server is located in the same physical computing device as the terminal.

The content of the file which is synchronously uploaded is divided into at least two portions. The two portions make up the content of the entire individual file. The two portions comprise a head portion and a rest portion. The head portion of the content is an initial segment of the file (e.g., the initial byte to the initial few bytes of the file). For example, the head portion of the content of a text file may be the first N pages of an completed text file, wherein N is a positive number that is smaller or equal to the total number of pages within the text document. The head portion of the content of an audio/video file may be the initial N minutes of the audio code stream of the file, wherein N is a positive number that is smaller or equal to the total number of minutes of the audio code stream.

The relationship between each divided portion of the content of file is established by the server, wherein, the head portion of the content of file may record an identity mark of the rest portion of the content of this file. In this case, even if the file corresponding to the head portion is operated on, such as name changing, etc., due to the identity mark of the rest portion of the content of this file recorded thereof, the rest portion may be found based on the identity mark and combined to the head portion.

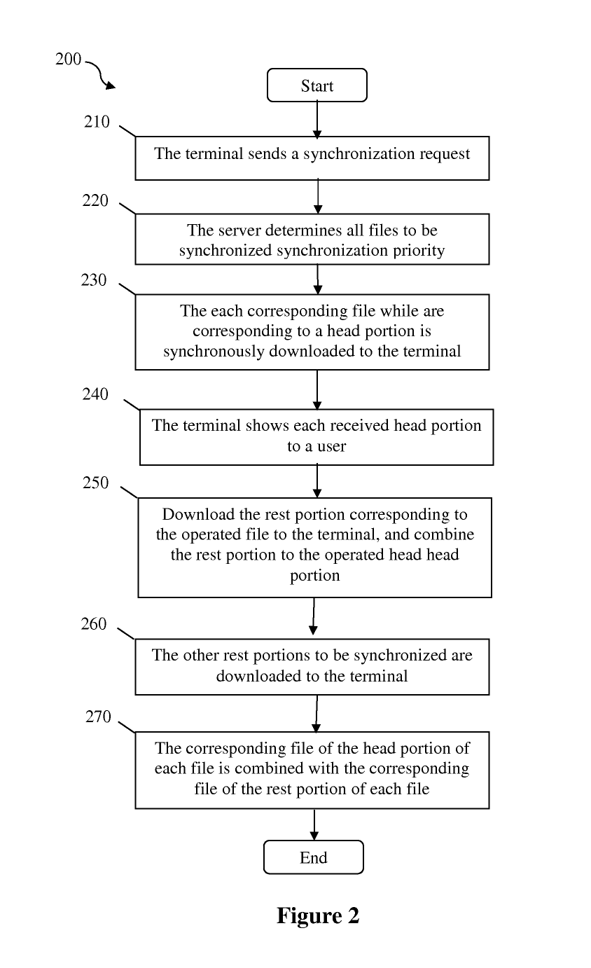

When the user starts to download each file from the server at the terminal, as a flow chart of FIG. 2 shown, the synchronization method according to the present invention comprises the following steps:

Step 210: the terminal sends a request including information about a device type of the terminal and a username of the user to the server.

The device type may be a tablet device type, a mobile device type, laptop device type, a business computer device type, etc. The device type is recorded in the operating system of the terminal, and can be obtained based on the model information of the terminal. For example, the model type of “Yangtian M” recorded in the system of a computer indicates that the computer is a business model manufactured by the Lenovo group. If the terminal cannot identify its device type, it may acquire its device type from the server by sending its model information to the server by which the device type of the terminal is retrieved from the website or database of the device provider via internet.

It is not difficult to understand that the synchronization request may be also sent actively by the server in this step. The sender of the request is not the point of the present invention, and thus no more unnecessary details are given.

Step 220: the server receives the request sent by the terminal. First, the files to be synchronized are determined on the basis of the username included in the information of the request.

The common file type corresponding to the device type in the information of the request is then determined on the basis of the common file type corresponding to the device type recorded on the server. The synchronous download order of the file with the common file type is set as higher priority than files with other file types. In addition, one device type can correspond to several common file types, and download orders with different priority associating with different file types can be set respectively.

The setting of synchronization download priority takes into account that purposes of operation are usually different when the user uses terminals with different device model. For example, in most cases, the user uses a tablet device or a mobile device to listen to music and watch video. Thus, the audio/video file types are set as the common file types for this kind of terminals. When the synchronous download is required, the audio/video files are downloaded with higher priority than other file types so that the user can obtain the synchronized audio/video file as soon as possible. As another example, in most cases, the user uses business computers for word processing. Thus, the text file type is set as a common file type for this kind of terminals so that text files are downloaded with higher priority than other file types when synchronous download is implemented.

The setting of synchronization priority order of file may be further dynamically adjusted based on the upload (or update) time of a file (timestamp), the number of operations being performed on a file (frequency stamp). For example, if the timestamp is closer to the current time, the file is paid much attention by the user, the priority of this file then can be promoted properly. If a file has more frequency stamps which indicate the file has been more frequently synchronized, the file is operated on much frequently by the user, the priority of this file then can be promoted properly.

Step 230: the server synchronously downloads the file corresponding to the head portion of the content of each file to be downloaded to the terminal in sequence on the basis of the determined priority order.

Step 240: the terminal receives the files corresponding to each head portion. Because the files corresponding to each head portion are independent with each other, the files may be presented within a graphical user interface to the user in the form of icon state or preview state.

At this moment, the user does not know the synchronously downloaded files are the files corresponding to each head portion and treats the synchronously downloaded files as each completely uploaded file. The user may initiate a preview, an icon view, a basic operation, such as file deleting, file name changing, executing (file opening) to the files corresponding to each head portion which are synchronously downloaded to the terminal. This may give the user a sense that the synchronization is completed quickly so that file can be operated as soon as possible.

Step 250: the user selects a certain head portion file (e.g., by clicking on the icon associated with the file), that is, opens the file corresponding to the head portion. The terminal identifies the rest portion that corresponds to the file being opened based on the identity mark recorded in the head portion file, and downloads the file corresponding to the rest portion of the file from the server, and then combines the file corresponding to the rest portion with the file corresponding to the head portion.

For example, when a user opens a file which corresponds to the head portion of a certain audio/video file, the file corresponding to the rest portion is synchronously downloaded and combined with the file corresponding to the head portion behind the scene as the corresponding icon is clicked and the audio/video begins to play, so that the user can enjoy the completed audio/video file.

Step 260: the server synchronously downloads the files corresponding to other rest portions to the terminal in sequence on the basis of the priority order described in the step 230.

Step 270: the terminal combines each of the files corresponding to the head portions with each of the files corresponding to the rest portions in sequence.

It can be seen from above that in the present invention, when the synchronous download is being processed, first, only one portion (a file corresponding to head portion) of each file is downloaded, so that the amount of downloaded data is small (relative to the amount of data to download the entire file) and the file corresponding to the head portion of each uploaded file may be downloaded very soon. The user may browse the icons, perform basic operations on the files. This method also gives the user a sense that the synchronization of each file is completed very quickly. The terminal may download the rest portion of a file when the file is being operated on by the user, and combine the file corresponding to the head portion with the file corresponding to the rest portion so that the file operated by the user is a completed file.

The present invention is especially suitable for a case under which the files to be synchronized are large files such as multiple audio, video or the like. The method according to the present invention gives the user a sense that the synchronization of each audio/video file is completed very fast, and each file can be browsed and watched, and any synchronized file can be used immediately. The user has a sense that there is no need to wait, and synchronization of each file is completed in a short time, at meanwhile the file can be used.

In addition, because the method of the present invention especially suitable for the large files, when the server divides a file, it may set the size of the head portion, such as 5 megabytes (MB), that is, the file is divided into a 5 MB head portion and the rest portion. The files of which the size is less than 5 MB are not necessary to be divided.

Furthermore, in consideration of the different network speed of terminals, the size of file may be set dynamically, that is, determining the network speed used by a terminal for synchronously downloading, i.e. network bandwidth, and then determining the size of the head portion based on the network bandwidth. If the network bandwidth is more enough to support a burst transmission for multiple large files, the more bytes may be allocated to the head portion to provide more contents to the user. This result in that the file division is difficult to be noticed by the user and a good experience for operating synchronized file is guaranteed for the user when the user operates the file corresponding to the head portion, such as browsing, opening the file. If the network bandwidth is little, the transmission for multiple large files will be very slow, and thus the less bytes may be allocated to the head portion to guarantee the head portion of each file to be downloaded quickly to the terminal so that the user may not feel the existence of the file synchronization, i.e. the file synchronization is completed very soon, while the user can operate the file, such as browsing, opening file and etc.

The above description is the proper embodiment of the present invention only, and is not used to limit the present invention. Any amendment, replacement, improvement and etc included within the principle of the present invention, shall be contained in the protection range of the present invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for synchronizing a file, comprising the following steps:
receiving synchronously uploaded files, dividing content of each of the uploaded files into a head portion and a rest portion, and producing corresponding files which respectively correspond to the head portion and the rest portion by means of a server;
downloading the corresponding files which correspond to the head portions of the content of the uploaded files to a terminal by means of the server; and
downloading the corresponding files which correspond to the rest portions of the content of the uploaded files to the terminal, and combining each of the corresponding files which correspond to the rest portions with a corresponding file which corresponds to the head portion by means of the server.

2. The method of claim 1, further comprising the following step:
presenting each of the corresponding files which correspond to the head portions in a form of an icon or a preview to a user by means of the terminal,
wherein the presenting step is performed after the step of downloading the corresponding files which correspond to the head portions and before the step of downloading the corresponding files which correspond to the rest portions.

3. The method of claim 1, further comprising the following step:
identifying a file that is currently being operated on by the user by means of the terminal, downloading a corresponding file which corresponds to a rest portion of the currently operated file to the terminal, and combining the rest portion of the currently operated file with a head portion of the currently operated file,
wherein the identifying, downloading, and combining are performed before the step of downloading the corresponding files which correspond to the rest portions.

4. The method of claim 1, wherein the downloading of the corresponding files which correspond to the head portions and the downloading of the corresponding files which correspond to the rest portions comprise downloading based on a priority order.

5. The method of claim 4, wherein the terminal is of a particular device model among a plurality of different device models, wherein the priority order is determined based on a pre-identified mapping between each of the plurality of different device models to a set of common file types.

6. The method of claim 5, wherein the priority order is further determined based on a file updating time, and the operating frequency of a file.

7. The method of claim 5, wherein the mapping between each of the plurality of different device models to a set of common file types comprises:
a mapping between a mobile terminal device model and an audio/video file type; and
a mapping between a business terminal device model and a text file type.

8. The method of claim 1, wherein
each of the corresponding files which corresponds to the head portion of the content of the uploaded file stores an identity mark of the corresponding file which corresponds to the rest portion of the content of the uploaded file; and
the step of combining comprises combining each of the corresponding files which corresponds to the head portion with a corresponding file which corresponds to the rest portion based on the identity mark.

9. The method of claim 1, wherein
the step of dividing comprises determining a size of the head portion, wherein a size of the uploaded file to be divided is larger than the determined size of the head portion.

10. The method of claim 9, wherein the step of determining the size of the head portion comprises:
determining a network bandwidth of file transmission between the server and the terminal; and
determining the size of the head portion based on the determined bandwidth.
